(19) United States
(12) Patent Application Publication
(10) Pub. No.: US 2011/0013943 A1
(43) Pub. Date: Jan. 20, 2011

(54) DEVELOPING DEVICE AND IMAGE FORMING APPARATUS

(75) Inventors: Takashi Sakamoto, Kanagawa (JP); Hiroaki Ohkuma, Kanagawa (JP); Daisuke Nakai, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/775,893

(22) Filed: May 7, 2010

(30) Foreign Application Priority Data
Jul. 15, 2009 (JP) 2009-167182

(51) Int. Cl. G03G 15/08

(52) U.S. Cl. 399/254

(57) ABSTRACT

A developing device includes a first chamber, a second chamber, a first inlet portion, a first carrying member and an auxiliary blade. The first chamber receives a developer supplied to a developer holder. The second chamber receives the developer carried from the first chamber after being circulated between the first chamber and the second chamber. The first inlet portion allows the developer to be introduced from the second chamber to the first chamber. The first carrying member is disposed in the first chamber to carry the developer in the first chamber in a first carrying direction. The first carrying member includes a rotating shaft, a spiral blade provided at an outer periphery of the rotating shaft, and the auxiliary blade formed toward an upstream side of the first carrying direction from the spiral blade.

### CROSS-REFERENCE TO RELATED APPLICATION

This application is based on and claims priority under 35 USC 119 from Japanese Patent Application No. 2009-167182 filed on Jul. 15, 2009.

### BACKGROUND

### Technical Field

The present invention relates to a developing device and an image forming apparatus.

### SUMMARY

According to an aspect of the invention, a developing device includes a developer holder, a first chamber, a second chamber, a first inlet portion, a second inlet portion, a first carrying member and a second carrying member. The developer holder rotates while the developer holder holds developers on a surface of the developer holder. The first chamber contains the developers supplied to the developer holder. The second chamber contains the developers carried from the first chamber after the developers are circulated between the first chamber and the second chamber. The first inlet portion connects the first chamber and the second chamber. At least a part of the first inlet portion overlapping a developer-holding portion of the developer holder. The second inlet portion connects the first chamber and the second chamber. The first carrying member is disposed in the first chamber, and carries the developers in the first chamber in a first carrying direction directed toward the second inlet portion. The second carrying member is disposed in the second chamber, and carries the developers in the second chamber in a second carrying direction directed toward the first inlet portion. The first carrying member includes (i) a rotating shaft, (ii) a spiral blade provided at an outer periphery of the rotating shaft, and (iii) an auxiliary blade formed toward an upstream side of the first carrying direction from the spiral blade wall. A gap is formed between an upstream end of the auxiliary blade and the spiral blade and the spiral blade wall in the first carrying direction.

### BRIEF DESCRIPTION OF THE DRAWINGS

Exemplary embodiments of the invention will be described in detail based on the following figures, wherein:

FIG. 1 is a diagram illustrating the whole of an image forming apparatus according to a first embodiment of the present invention;

FIG. 2 is an enlarged view illustrating main elements of an image forming apparatus according to a first embodiment;

FIGS. 3A to 3C are diagrams illustrating the whole of a developing device according to a first embodiment of the present invention, in which FIG. 3A is a sectional perspective view illustrating main elements when a developing container cover is removed, FIG. 3B is a diagram illustrating a supply auger, and FIG. 3C is a diagram illustrating a stirring auger;

FIG. 4 is a sectional view taken along line IV-IV of FIG. 3A;

FIG. 5 is a sectional view taken along line V-V of FIG. 3A;

FIGS. 6A to 6C are diagrams illustrating an upstream end portion of a supply auger according to a first embodiment, in which FIG. 6A is an enlarged view illustrating main elements of the supply auger, FIG. 6B is a diagram illustrating the carrying of developers by a blade, and FIG. 6C is a diagram illustrating the amount of developers interposed between blades;

FIG. 7 is an enlarged view illustrating main elements of a downstream end portion of a supply auger according to a first embodiment; and

FIGS. 8A to 8D are diagrams illustrating a conventional developer carrying member, in which FIG. 8A is a diagram illustrating the configuration in which no gap is formed in the developer carrying member, FIG. 8B is a diagram illustrating the state in which the state shown in FIG. 8A is rotated by 90°, FIG. 8C is a diagram illustrating the configuration in which a phase is not synchronized, and FIG. 8D is a diagram illustrating a state in which the state shown in FIG. 8C is rotated by 90°.

### DETAILED DESCRIPTION

Hereinafter, an embodiment of the present invention will be described in detail with reference to the accompanying drawings. However, the present invention is not limited to the embodiment below.

To facilitate the understanding of the following description, in the drawings, a front and rear direction will be referred to as an X axis direction, a right and left direction will be referred to as a Y axis direction, and an upper and lower direction will be referred to as a Z axis direction. Further, a direction or a side indicated by arrows X, −X, Y, −Y, Z and −Z will be referred to as the front, the rear, the right, the left, the upward and the downward, or the front side, the rear side, the right side, the left side, the upper side and the lower side, respectively.

In addition, in the drawings, the symbol obtained by inserting [•] into [O] means an arrow toward the surface from the back of a paper and the symbol obtained by inserting [x] into [O] means an arrow toward the back from the surface of the paper.

Moreover, in the description using the accompanying drawings, members other than members necessary for helping the understanding of the description will be appropriately omitted.

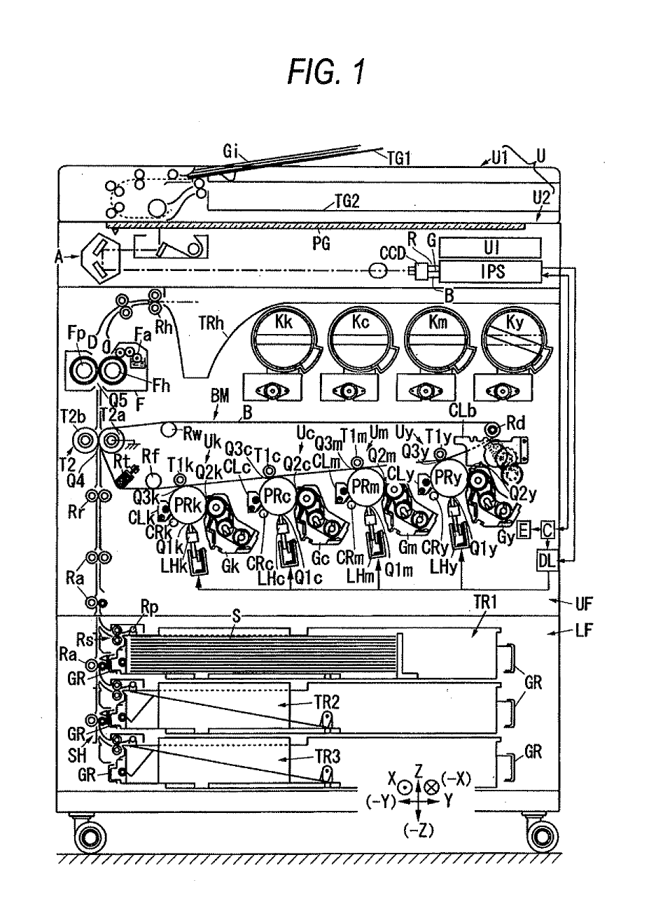

FIG. 1 is a diagram illustrating the whole of an image forming apparatus according to a first embodiment of the present invention.

In FIG. 1, a copy machine U as one example of the image forming apparatus includes an automatic original document carrying apparatus U1, and an apparatus body U2 that supports the automatic original document carrying apparatus U1 and is provided at the upper end thereof with a transparent original document reading surface PG.

The automatic original document carrying apparatus U1 includes an original document feeding unit TG1, which receives a plurality of piled original documents Gi to be copied, and an original document discharge unit TG2 which discharges the original documents Gi having passed through an original document reading position on the original document reading surface PG after being fed from the original document feeding unit TG1.

The apparatus body U2 includes a manipulation unit U1, through which a user inputs an operation indication signal such as an image forming operation start, an exposure optical system A and the like.

In the automatic original document carrying apparatus U1, a reflection light from an original document, which is carried on the original document reading surface PG or an original document loaded on the original document reading surface PG, is converted into an electrical signal of red (R), green (G) and blue (B) by a solid-state imaging device CCD via the exposure optical system A.

An information conversion unit IPS converts the electrical signal of RGB input from the solid-state imaging device CCD into image information of black (K), yellow (Y), magenta (M) and cyan (C), temporarily stores the image information, and then outputs the image information to a latent image forming circuit DL as image information for latent image formation at the preset time.

Further, when an original document image is a monochromatic image, only image information of black (K) is input to the latent image forming circuit DL.

The latent image forming circuit DL includes driving circuits (not shown) of Y, M, C and K, and outputs a signal corresponding to the input image information to latent image forming units LHy, LHm, LHc and LHk provided for each color at the preset time.

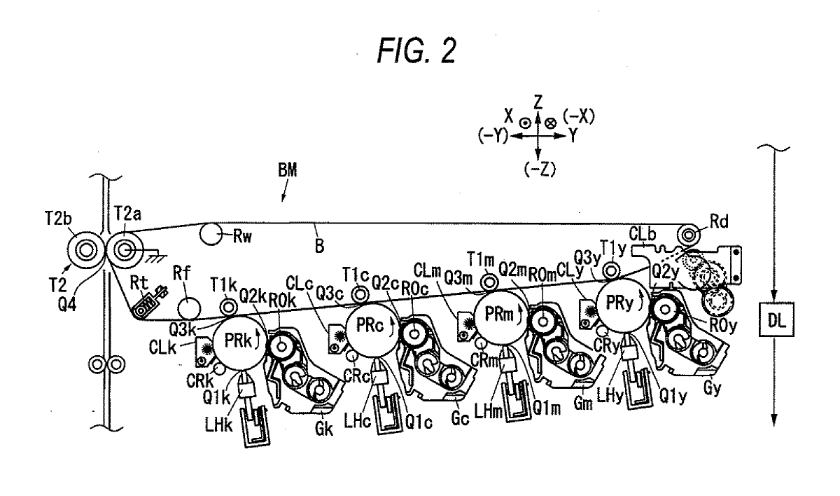

FIG. 2 is an enlarged view illustrating main elements of the image forming apparatus according to the first embodiment.

Visible image forming devices Uy, Um, Uc and Uk provided at the center portion of the gravitational direction of the copy machine U form visible images of each color of Y, M, C and K respectively.

Latent image writing lights Ly, Lm, Lc and Lk of Y, M, C and K, which are emitted from light sources of the latent image forming units LHy, LHm, LHc and LHk, are incident into photoreceptors PRy, PRm, PRc and PRk as one example of an image holder. Further, in the first embodiment, the latent image forming units LHy, LHm, LHe and LHk are prepared in the form of an apparatus, in which LEDs (Light Emission Diodes) serving as writing devices are linearly arranged in a row, that is, an LED array.

The visible image forming device Uy of Y includes the rotary photoreceptor PRy, a charger CRy, the latent image forming unit LHy, a developing device Gy, a primary transfer unit T1y, and a photoreceptor cleaner CLy as one example of an image holder cleaner. Further, in the first embodiment, the rotary photoreceptor PRy, the charger CRy and the photoreceptor cleaner CLy are prepared in the form of an image holder unit integrally attachable and detachable from the apparatus body U2.

Each of the visible image forming devices Urn, Uc and Uk has the same configuration as that of the visible image forming device Uy of Y.

In FIGS. 1 and 2, the photoreceptors PRy, PRm, PRc and PRk are charged by the chargers CRy, CRm, CRc, CRk, respectively. Then, latent images are formed on the surfaces of the photoreceptors PRy, PRm, PRc and PRk by the latent image writing lights Ly, Lm, Lc and Lk in image writing positions Q1y, Q1m, Q1c and Q1k. The latent images on the surfaces of the photoreceptors PRy, PRm, PRc and PRk are developed into toner images as one example of a visible image by developers held on developing rolls R0y, R0m, R0c and R0k as one example of a developer holder of developing devices Gy, Gm, Gc and Gk in development areas Q2y, Q2m, Q2c and Q2k.

The developed toner images are carried to primary transfer areas Q3y, Q3m, Q3c and Q3k being in contact with an intermediate transfer belt B as one example of an intermediate transfer unit. A primary transfer voltage with a polarity opposite to a charge polarity of toner is applied from a power circuit E controlled by a control unit C to primary transfer units T1y, T1m, T1c and T1k, which are disposed at the back side of the intermediate transfer belt B in the primary transfer areas Q3y, Q3m, Q3c and Q3k.

The toner images on the photoreceptors PRy, PRm, PRc and PRk are primarily transferred to the intermediate transfer belt B as one example of the intermediate transfer unit by the primary transfer units T1y, T1m, T1c and T1k. Residue and attachments on the surfaces of the photoreceptors PRy, PRm, PRc and PRk after the primary transfer are cleaned by photoreceptor cleaners CLy, CLm, CLc and CLk. The cleaned surfaces of the photoreceptors PRy, PRm, PRc and PRk are charged again by the chargers CRy, CRm, CRc, CRk, respectively.

A belt module BM as one example of an intermediate transfer device is disposed above the photoreceptors PRy, PRm, PRc and PRk. The belt module BM includes the intermediate transfer belt B, a belt driving roll Rd as one example of an intermediate transfer unit driving member, a tension roll Rt as one example of a tension applying member, a walking roll Rw as one example of a meandering prevention member, an idler roll Rf as one example of a driven member, a backup roll T2a as one example of a secondary transfer facing member, and the primary transfer units T1y, T1m, T1c and T1k. Further, the intermediate transfer belt B is rotatably and movably supported by the rolls Rd, Rt, Rw, Rf and T2a.

A secondary transfer roll T2b as one example of a secondary transfer member is disposed to face the surface of the intermediate transfer belt B being in contact with the backup roll T2a. A secondary transfer unit T2 is formed by the backup roll T2a and the secondary transfer roll T2b. Further, a secondary transfer area Q4 is formed by an area facing the secondary transfer roll T2b and the intermediate transfer belt B.

Monochromatic or multi-colored toner images, which are sequentially piled and transferred on the intermediate transfer belt B by the primary transfer units T1y, T1m, T1c and T1k in the primary transfer areas Q3y, Q3m, Q3c and Q3k, are carried to the secondary transfer area Q4.

Transfer devices T1+T2+B, which transfer the images formed on the photoreceptors PRy, PRm, PRc and PRk to a medium, according to the first embodiment are formed by the primary transfer units T1y, T1m, T1c and T1k, the intermediate transfer belt B, the secondary transfer unit T2 and the like.

A pair of right and left guide rails GR having a three-stage structure as one example of a guide member are provided below the visible image forming devices Uy, Urn, Uc and Uk. Feeding trays TR1 to TR3 as one example of a feeding unit are supported so as to move in the front and rear direction. In the guide rails GR, Recording sheets S as one example of media received in the feeding trays TR1 to TR3 are extracted by a pick-up roll Rp as one example of a medium extraction device, and then are separated one by one by a handling roll Rs as one example of a medium handling member. Further, the recording sheets S are carried by a plurality of carrying rolls Ra as one example of a medium carrying member along a sheet carrying path SH as one example of a medium carrying path, and then are sent to a register roll Rr as one example of a time adjustment member disposed at an upstream side of a sheet carrying direction of the secondary transfer area Q4. A sheet carrying device SH+Ra+Rr is formed by the sheet carrying path SH, the sheet carrying rolls Ra, the register roll Rr and the like.

The register roll Rr carries the recording sheet S to the secondary transfer area Q4 according to the time at which the toner image formed on the intermediate transfer belt B is carried to the secondary transfer area Q4. When the recording sheet S passes through the secondary transfer area Q4, the backup roll T2a is grounded, and a secondary transfer voltage with a polarity opposite to the charge polarity of the toner is applied to the secondary transfer roll T2b from the power circuit E controlled by the control unit C. At this time, the toner image on the intermediate transfer belt 13 is transferred to the recording sheet S by the secondary transfer unit T2.

The intermediate transfer belt B after the secondary transfer is cleaned by a belt cleaner CLb as one example of an intermediate transfer unit cleaner.

The recording sheet S, on which the toner image is secondarily transferred, is carried to a fixing area Q5 which is a contact area between a heating roll Fh as one example of a heating and fixing member of a fixing device F and a pressing roll Fp as one example of a pressing and fixing member, and heated and fixed when passing through the fixing area. The heated and fixed recording sheet S is discharged from a discharge roll Rh as one example of a medium discharge member to a discharge tray TRh as one example of a medium discharge unit.

Further, a release agent is coated on the surface of the heating roll Fh by a release agent coating device Fa to improve release properties of the recording sheet S from the heating roll.

Developer cartridges Ky, Km, Ke and Kk as one example of a developer receiving container, which receive developers of yellow Y, magenta M, cyan C and black K, are disposed above the belt module BM. The developers received in the developer cartridges Ky, Km, Ke and Kk are supplied to the developing devices Gy, Gm, Ge and Gk with the consumption of developers in the developing devices Gy, Gm, Gc and Gk. According to the first embodiment, the developers received in the developing devices Gy, Gm, Ge and Gk are formed by two-component developers including magnetic carrier and toner to which external additive is added, and so-called high density toner with a high ratio of toner with respect to a carrier is supplied from the developer cartridges Ky, Km, Ke and Kk, as compared with the developers in the developing devices Gy, Gm, Gc and Gk.

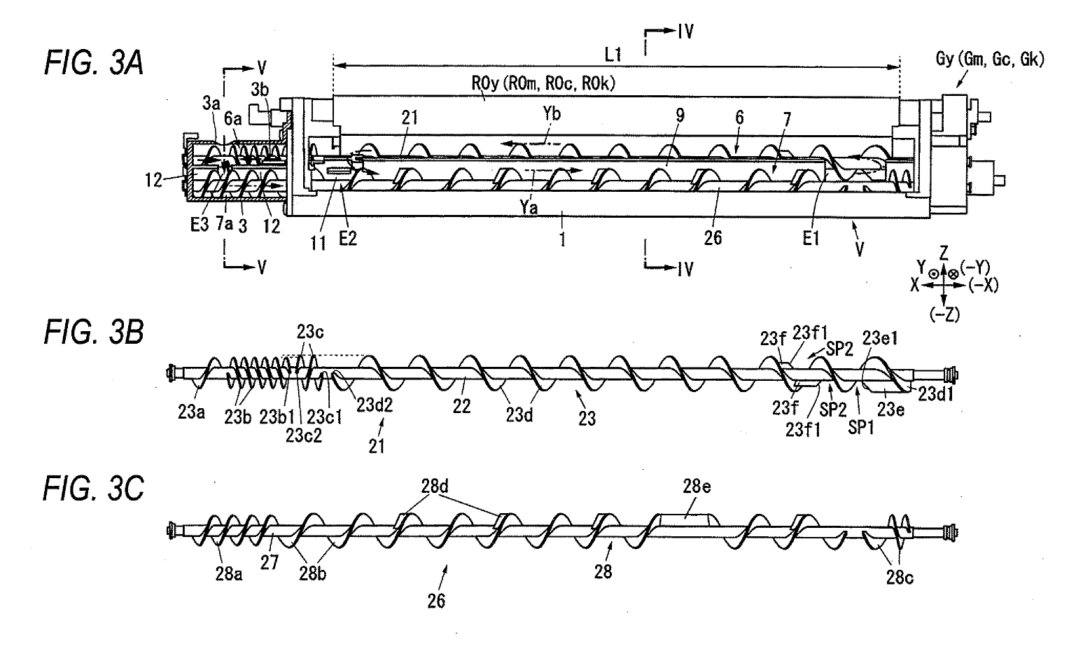

FIGS. 3A to 3C are diagrams illustrating the developing device according to the first embodiment of the present invention, in which FIG. 3A is a sectional perspective view illustrating main elements when a developing container cover is removed, FIG. 3B is a diagram illustrating a supply auger, and FIG. 3C is a diagram illustrating a stirring auger.

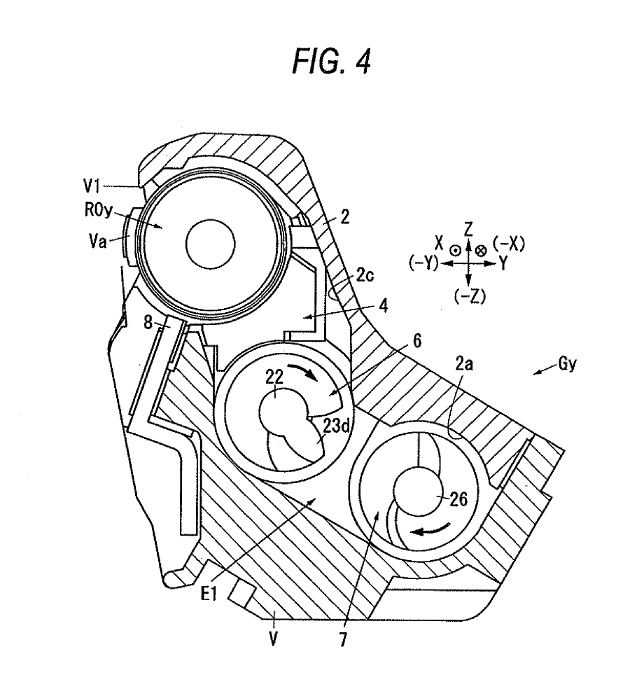

FIG. 4 is a sectional view taken along line 1V-1V of FIG. 3A.

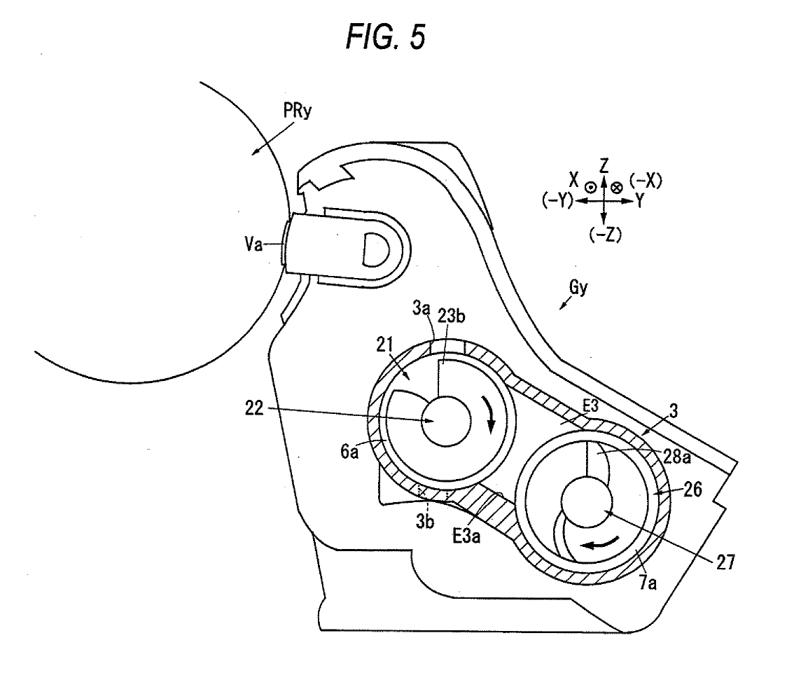

FIG. 5 is a sectional view taken along line V-V of FIG. 3A.

Next, the developing devices Gy, Gm, Gc and Gk according to the first embodiment of the present invention will be described. However, since the developing devices Gy, Gm, Gc and Gk of each color have the same configuration, only the developing device Gy of a Y color will be described in detail, and detailed description of the developing devices Gm, Ge and Gk of other colors will be omitted.

In FIGS. 2 to 5, the developing device Gy facing the photoreceptor PRy includes a development container V that receives the two-component developers including the toner and the carrier. The development container V includes a development container body 1, a development container cover 2 that covers the upper end of the development container body 1 as one example of a cover member as shown in FIG. 4, and a supply and disposal tube 3 connected to the front end of the development container body 1 as one example of a supply and disposal unit as shown in FIG. 3A to 3C, In FIG. 4, the development container V according to the first embodiment is formed with an opening V1 corresponding to the development area Q2y facing the photoreceptor Pry, and is opened.

In FIGS. 2 to 4, the development container body 1 is provide therein with a developing roll chamber 4 as one example of a holder receiving unit, a first stirring chamber 6 as one example of a first chamber, and a second stirring chamber 7 as one example of a second chamber. The first stirring chamber 6 is adjacent to the developing roll chamber 4. The second stirring chamber 7 is adjacent to the right oblique lower portion of the first stirring chamber 6 to reduce the size of the transverse and longitudinal direction of the development container V. A developing roll R0y as one example of a developer holder is received in the developing roll chamber 4, and a part of an outer surface of the developing roll R0y is exposed to the photoreceptor PRy in the opening V1 while facing the photoreceptor PRy. A layer thickness regulation member 8 is provided at an upstream side of the rotation direction of the developing roll R0y to restrict the layer thickness of the developer on the surface of the developing roll R0y.

Further, in FIG. 4, abutment members Va (i.e., tracking members) are provided at both front and rear end portions of the development container V while facing the photoreceptor Pry to maintain a predetermined gap between the developing roll R0y and the photoreceptor Pry.

In FIG. 3A to 3C, a supply and disposal chamber 6a in the supply and disposal tube 3 is connected to the front side of the first stirring chamber 6, and a supply chamber 7a in the supply and disposal tube 3 is connected to the front side of the second stirring chamber 7. In FIG. 3A to 3C, a developer supply port 3a as one example of a new developer inlet portion is formed in the upper surface of the front end portion of the supply and disposal chamber 6a to allow developers to be supplied from the developer cartridges Ky, Km, Kc and Kk. Further, in FIGS. 3A to 3C and 5, a developer discharge port 3b as one example of a developer discharge unit is formed in the lower surface of the rear portion of the supply and disposal chamber 6a, and deteriorated developers in the supply and disposal chamber 6a are discharged from the developer discharge port 3b, so that internal carriers are exchanged little by little.

As shown in FIG. 3A to 3C, a partition wall 9 is provided between the first stirring chamber 6 and the second stirring chamber 7, except for both ends of the development container body 1. In FIGS. 3A to 3C and 4, the first stirring chamber 6 and the second stirring chamber 7 communicate with each other in an ascending inlet portion E1 as one example of a first inlet portion disposed at the rear end portion of the partition wall 9, and a descending inlet portion E2 as one example of a second inlet portion disposed at the front side of the partition wall 9. The ascending inlet portion E1 and the descending inlet portion E2 are configured to facilitate the circulation of developers. The descending inlet portion E2 is provided with an opening forming member 11 formed with an opening for adjusting the inlet flow.

In FIG. 3A, according to the first embodiment, the ascending inlet portion E1 overlaps the width L1 of the development area Q2y, on which development is performed by the developing roll R0y, and a part of the descending inlet portion E2 overlaps the width L1 of the development area Q2y.

Further, in the developer supply and disposal tube 3, a partition wall 12 is formed between the supply and disposal chamber 6a and the supply chamber 7a. Thus, as shown in FIG. 3A to 3C, the supply and disposal chamber 6a and the supply chamber 7a communicate with each other in a supply inlet portion E3 as one example of a third inlet portion, and developers are introduced from the supply and disposal chamber 6a to the supply chamber 7a.

A circulation stirring chamber 6+7 is formed by the first stirring chamber 6 and the second stirring chamber 7.

In FIGS. 3A to 3C and 4, the first stirring chamber 6 is provided therein with a supply auger 21 as one example of a first carrying member for stirring and carrying developers and a supply member for supplying the developers to the developing roll R0y.

In FIGS. 3A and 3B, the supply auger 21 includes a first rotating shaft 22, which extends in parallel to the axial direction of the developing roll R0y, and a first carrying blade 23 supported on an outer periphery of the first rotating shaft 22 and having a spiral shape. The first carrying blade 23 includes a first supply carrying blade 23a as one example of a carrying blade, a discard carrying blade 23b as one example of a fourth carrying part, a circulation carrying blade 23c as one example of a reverse carrying part for circulation, and a first main carrying blade 23d as one example of a first carrying part. The first supply carrying blade 23a is disposed corresponding to the front end portion of the supply and disposal chamber 6a, and the discard carrying blade 23b is disposed corresponding to the rear portion from the center portion of the supply and disposal chamber 6a. The circulation carrying blade 23c is disposed corresponding to the front side of the descending inlet portion E2 from the rear end portion of the supply and disposal chamber 3a, and the first main carrying blade 23d is disposed corresponding to the rear end portion of the first stirring chamber 6 from the descending inlet portion E2.

The carrying blades 23a to 23d according to the first embodiment have a spiral shape, respectively. The winding direction of the first supply carrying blade 23a is opposite to that of the discard carrying blade 23b, the winding direction of the discard carrying blade 23b is opposite to that of the circulation carrying blade 23c, and the winding direction of the circulation carrying blade 23e is opposite to that of the first main carrying blade 23d.

Further, the distance by which developers are moved through one rotation of the first main carrying blade 23d, that is, an interval between blades adjacent to each other in the axial direction, in other words, a pitch is set to be larger than each of the carrying blades 23a to 23c. In addition, in FIGS. 4 and 5, according to the first embodiment, a sectional area of the supply and disposal chamber 6a is smaller than that of the first stirring chamber 6, so that outer diameters of the supply carrying blade 23a and the discard carrying blade 23b disposed in the supply and disposal chamber 6a are smaller than those of the circulation carrying blade 23c and the first main carrying blade 23d disposed in the first stirring chamber 6 as shown in FIG. 3B.

Moreover, the supply auger 21 according to the first embodiment is moved in the sequence of the upper portion in the gravitational direction, the second developer receiving chamber-side and the lower portion in the gravitational direction in the ascending inlet portion E1 as shown in FIG. 4. Similarly to this, the supply auger 21 is moved in the supply inlet portion E3 shown in FIG. 5 which will be described later.

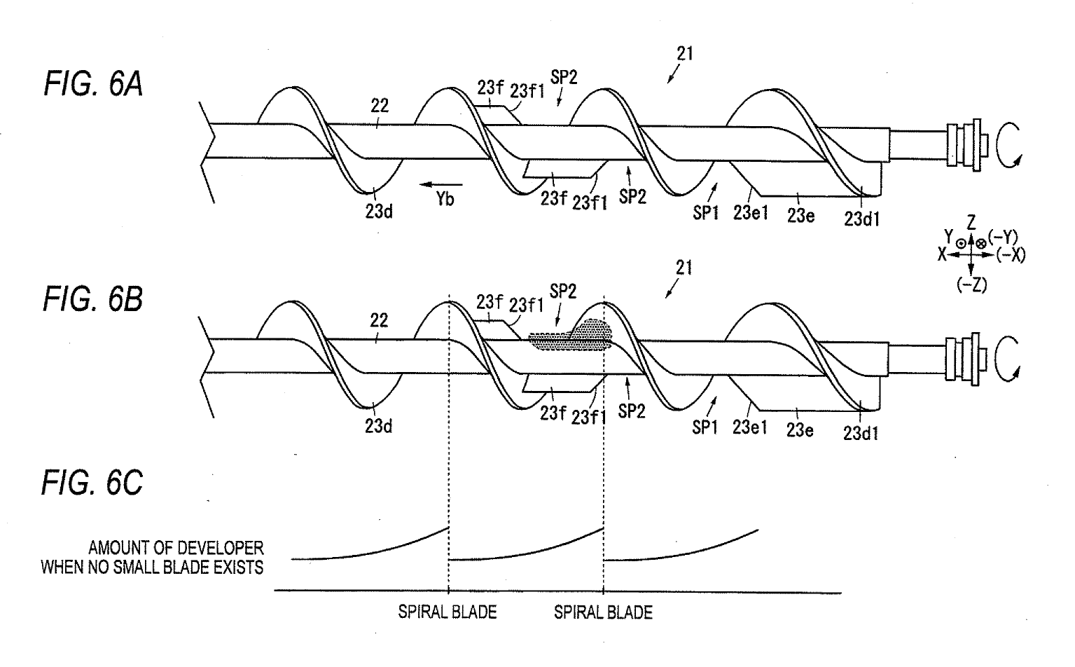

FIGS. 6A to 6C are diagrams illustrating an upstream end portion of the supply auger according to the first embodiment, in which FIG. 6A is an enlarged view illustrating main elements of the supply auger, FIG. 6B is a diagram illustrating the carrying of developers by a blade, and FIG. 6C is a diagram illustrating the amount of developers interposed between blades.

In FIGS. 3B and 6A to 6C, a rear end blade 23d1 corresponding to one winding of the first main carrying blade 23d having a spiral shape, which is located at a rear end (i.e., an upstream end) of the supply auger 21, has a pitch larger than that of the other blades in the first carrying direction Yb serving as a direction in which developers are carried by the first main carrying blade 23d. Thus, the rear end blade 23d1 of the first main carrying blade 23d is inclined with respect to the first rotating shaft 22, that is, is in a resting state, as compared with the other blades. Consequently, while an ability of the rear end blade 23d 1 to carry developers in the axial direction is reduced, and an ability of the rear end blade 23d1 to carry developers toward the developing roll R0y is increased, as compared with the other blades.

In FIGS. 3B and 6A to 6C, the supply auger 21 is provided at the rear end portion thereof with an upstream end paddle 23e as one example of a feeding blade. The upstream end paddle 23e according to the first embodiment has a plate shape to extend along the axial direction of the first rotating shaft 22. Further, the upstream end paddle 23e has an upstream end connected to the rear end blade 23d1, and a gap SP1 is formed between a downstream end surface 23e1 of the upstream end paddle 23e and the first main carrying blade 23d of the downstream side. In addition, according to the first embodiment, an outer end of a radial direction of the downstream end surface 23e1 of the upstream end paddle 23e is inclined toward a direction separated from the first rotating shaft 22 as it is toward a direction of the rear side (i.e., the upstream side).

Moreover, the outer diameter of the upstream end paddle 23e according to the first embodiment, except for the inclined downstream end surface 23e1, is set to be equal to that of the first main carrying blade 23d. Further, the upstream end paddle 23e is disposed corresponding to the ascending inlet portion E1 in such a manner that the upstream end paddle 23e and the ascending inlet portion E1 partially overlap each other.

In FIGS. 3B and 6A to 6C, a small blade 23f as one example of an auxiliary blade is provided in front of the upstream end paddle 23e. The small blade 23f according to the first embodiment has a plate shape to extend along the axial direction of the first rotating shaft 22. Further, a downstream end of the small blade 23f is connected to the first main carrying blade 23d, and a gap SP2 is formed between an upstream end surface 2311 of the small blade 23f and the first main carrying blade 23d of the upstream side. In addition, according to the first embodiment, an outer end of a radial direction of the upstream end surface 2311 of the small blade 23f is inclined toward a direction separated from the first rotating shaft 22 as it is toward a direction of the front side (i.e., the downstream side).

Moreover, the outer diameter of the small blade 23f according to the first embodiment, except for the inclined upstream end surface 2311, is set to be smaller than those of the first main carrying blade 23d and the upstream end paddle 23e.

Further, the small blade 23f is disposed at the downstream side as compared with the ascending inlet portion E1, and a front end of the upstream end surface 2311 of the small blade 23f is disposed adjacent to the downstream end of the ascending inlet portion E1. In addition, a part of the upstream end surface 2311 of the small blade 23f may overlap the ascending inlet portion E1, or the ascending inlet portion E1 may not overlap the small blade 23f.

Moreover, in the supply auger 21 according to the first embodiment, two small blades 23f having phases, which are different from each other by 180°, are disposed in the rotation direction of the first rotating shaft 22.

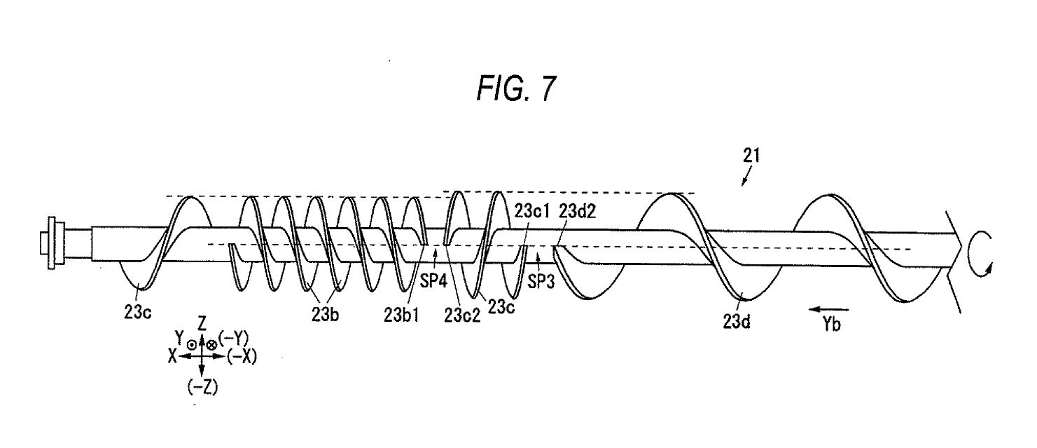

FIG. 7 is an enlarged view illustrating main elements of a downstream end portion of the supply auger according to the first embodiment.

Referring to FIGS. 3B and 7, in the supply auger 21 according to the first embodiment, a front end 23d2 serving as the downstream end of the first main carrying blade 23d is separated from a rear end 23c1 serving as the upstream end of the circulation carrying blade 23c in the axial direction of the first rotating shaft 22, and a gap SP3 is formed between the front end 23d2 and the rear end 23c1. Further, the front end 23d2 of the first main carrying blade 23d has the same phase as that of the rear end 23c1 of the circulation carrying blade 23c with respect to the rotation direction of the first rotating shaft 22.

In addition, according to the first embodiment, the circulation carrying blade 23c is formed by two windings necessary for making two circuits around the first rotating shaft 22. That is, the number of windings is set to 2.

Similarly to this, a front end 23c2 of the circulation carrying blade 23c is separated from a rear end 23b1 serving as the upstream end of the discard carrying blade 23b in the axial direction, and a gap SP4 is formed therebetween. Further, the front end 23c2 of the circulation carrying blade 23c has the same phase as that of the rear end 23b1 of the discard carrying blade 23b with respect to the rotation direction of the first rotating shaft 22.

In addition, in the supply auger 21 according to the first embodiment, the first rotating shaft 22 is integrally formed with the first carrying blade 23 by using resin. However, after the shaft is formed separately from the carrying blade, they may be combined with each other. Moreover, according to the first embodiment, the carrying blades 23a to 23d are provided to one first rotating shaft 22. However, the invention is not limited to such a configuration. For example, a carrying blade may be formed separately from a rotating shaft in the form of the first supply carrying blade 23a and a rotating shaft thereof, the discard carrying blade 23b and a rotating shaft thereof, the circulation carrying blade 23c and a rotating shaft thereof, and the first main stirring and carrying blade 23d and a rotating shaft thereof.

In FIGS. 3A and 3C, the second stirring chamber 7 is provided therein with a stirring auger 26 as one example of a second carrying member for stirring and carrying developers and a stirring member for stirring the developers. The stirring auger 26 includes a second rotating shaft 27, which extends along the axial direction of the developing roll R0y, and a second carrying blade 28 supported on an outer periphery of the second rotating shaft 27 and having a spiral shape. The second carrying blade 28 includes a second supply carrying blade 28a disposed corresponding to the supply chamber 7a, a second main carrying blade 28b disposed corresponding to the front side of the ascending inlet portion E1 from the descending inlet portion E2, and a reverse carrying blade 28c disposed at the rear end portion of the second stirring chamber 7.

In addition, according to the first embodiment, each of the blades 28a to 28c has a spiral shape, and the second main carrying blade 28b has a pitch larger than that of each of the carrying blades 23a to 23d. Moreover, as shown in FIGS. 3A to 3C, the second main carrying blade 28b is provided with a plurality of flat-plate shaped stirring members 28d formed at a predetermined interval while being supported by the second rotating shaft 27. In FIG. 3C, a stirring paddle 28e as one example of a stirring portion is provided at the left side of the reverse carrying blade 28c and is supported by the second rotating shaft 27. In relation to the stirring member 28d and the stirring paddle 28e, a carrying force in the circumferential direction is larger than a carrying force along the axial direction of the second rotating shaft 27. Particularly, according to the first embodiment, the stirring member 28d and the stirring paddle 28e are made of a material having a plate shape along the second rotating shaft 27, and carrying force of the axial direction due to the stirring member 28d and the stirring paddle 28e rarely exists.

Similarly to the supply auger 21, the stirring auger 26 according to the first embodiment is also integrally formed. In addition, according to the first embodiment, the blades 28a to 28c are provided to one second rotating shaft 27. However, the invention is not limited to such a configuration. For example, a carrying blade may be formed separately from a rotating shaft in the form of the second supply carrying blade 28a and a rotating shaft thereof, the second main carrying blade 28b and a rotating shaft thereof, and the reverse carrying blade 28c and a rotating shaft thereof.

If each carrying member 21 or 26 rotates, developers supplied from the developer supply port 3a are introduced to the supply inlet portion E3 by the first supply carrying blade 23a and the discard carrying blade 23b, and then are carried to the supply chamber 7a. The developers carried to the supply chamber 7a are carried to the second stirring chamber 7 in the development container body 1 by the second supply carrying blade 28a, and then are carried in the second carrying direction Ya by the second main carrying blade 28b. The developers carried to the ascending inlet portion E1 are made to stay by the second main carrying blade 28b and the reverse carrying blade 28c, which carries developers in the direction opposite to the second carrying direction, so that the amount of the developers is increased. Then, the developers are carried to the first stirring chamber 6 located diagonally above. At this time, according to the first embodiment, since the second stirring chamber 7 is disposed adjacent to the right oblique lower portion of the first stirring chamber 6, the stirring auger 26 disposed in the second stirring chamber 7 rotates in the clockwise direction in FIG. 4, that is, in the sequence of the lower portion in the gravitational direction, a side facing the first stirring chamber 6 and the upper portion in the gravitational direction. At the time of the rotation of the stirring auger 26, the developers are carried to the left upper portion by the second main carrying blade 28b and the reverse carrying blade 28c, that is, the developers are carried in such a manner that the developers approach the first stirring chamber 6 so as to be lifted up, so that the introduction of the developers to the first stirring chamber 6 is supported.

The developers introduced to the first stirring chamber 6 are carried in the first developer carrying direction Yb opposite to the second developer carrying direction Ya by the first main carrying blade 23d. The developers carried to the first stirring chamber 6 are attached to the surface of the developing roll R0y by a magnetic force during the carrying, and are used for development. The developers carried to the descending inlet portion E2 are made to stay in the descending inlet portion E2 due to the circulation carrying blade 23c which carries developers in the direction opposite to the first developer carrying direction Yb, and then are introduced to the second stirring chamber 7 through the descending inlet portion E2 by gravity. As a result, the developers in the stirring chambers 6 and 7 are stirred by the stirring members 21 and 26 so as to be circulated and carried.

Further, if the developers of the descending inlet portion E2 are increased, a case may occur in which a part of the developers are introduced to the discard carrying blade 23b of the supply and disposal chamber 7a without being carried in the opposite direction by the circulation carrying blade 23c. In such a case, the developers introduced to the discard carrying blade 23b after passing through the circulation carrying blade 23c are carried to the developer discharge port 3b by the discard carrying blade 23b so as to be discarded. Thus, deteriorated developers due to a load during the development are discarded from the developer discharge port 3b slowly.

In the copy machine U having the above configuration according to the first embodiment, developers circulated in the developing devices Gy, Gm, Ge and Gk are lifted up and pumped in the ascending inlet portion E1 in the direction opposite to the gravitational direction, and then the pumped developers are carried to the downstream side by the supply auger 21. However, in the developing devices Gy, Gm, Ge and Gk in which the ascending inlet portion E1 exists in the width L1 of the development areas Q2y, Q2m, Q2c and Q2k, if the pumped developers are carried at a high speed by the supply auger 21, the rear end portion of the developing roll R0y lacks developers, so that a shortage in the supply of developers may occur in the developing rolls R0y, R0m, R0c and R0k, resulting in the occurrence of image formation failure. In this regard, according to the first embodiment, since the upstream side paddle 23e having no ability to carry developers is disposed corresponding to the end portion of the developing rolls R0y, R0m, R0c and R0k, carrying performance, carrying ability and carrying speed of the developers pumped to the first stirring chamber 6 are reduced, and the upstream side paddle 23e sends the developers toward the developing rolls R0y, R0m, R0c and R0k. Consequently, a short in the supply of developers can be prevented from occurring in the end portion of the developing rolls R0y, R0m, R0c and R0k, and development unevenness and density unevenness can be prevented from occurring in the axial direction of the developing rolls R0y, R0m, R0c and R0k.

Further, according to the first embodiment, an inclination angle of the rear end blade 23d1 of the first main carrying blade 23d is small as compared with the other blades, and is adjacent to the upstream side paddle 23e, so that the carrying ability thereof is reduced. Consequently, developers can be easily supplied to the end portion of the developing rolls R0y, R0m, R0c and R0k, and a shortage in the supply of developers can be prevented.

In addition, according to the first embodiment, the gap SP1 is formed between the downstream end surface 23e1 of the upstream end paddle 23e and the first main carrying blade 23d of the downstream side, so that the developer carrying ability can be prevented from being reduced and a shortage in the supply of developers can be prevented from occurring in the downstream side of the upstream end paddle 23e, as compared with the case in which the gap SP1 is not formed.

Moreover, according to the first embodiment, the downstream end surface 23e1 of the upstream end paddle 23e is inclined such that the diameter thereof is increased toward the rear side. However, in the case in which the downstream end surface 23e1 is not inclined and extends in the radial direction perpendicular to the first rotating shaft 22, the developer carrying ability may be discontinuously changed and density unevenness may occur in the end portion of the developing rolls R0y, R0m, R0c and R0k when the downstream end surface 23e1 is set as a boundary. In this regard, in the supply auger 21 according to the first embodiment in which the downstream end surface 23e1 is inclined, the carrying force is changed slowly and density unevenness can be prevented from occurring in the end portion of the developing rolls R0y, R0m, R0c and R0k.

Furthermore, according to the first embodiment, the small blade 23f is formed at the downstream side of the upstream end paddle 23e, so that the force carrying developers is reduced. Consequently, the upstream end paddle 23e reduces the carrying ability, and the amount of developers carried to the downstream side at which the small blade 23f is disposed is reduced, as compared with the configuration in which the small blade 23f is not provided. For example, if the total amount of developers in the developing devices Gy, Gm, Gc and Gk is reduced due to the continuous development and the like in the state in which the developer cartridges Ky, Km, Kc and Kk are empty, a shortage in the supply of developers may occur in the downstream side of the upstream side paddle 23e. In this regard, according to the first embodiment, the small blade 23f having a low developer carrying ability is disposed at the downstream side of the upstream side paddle 23e to reduce the carrying ability, so that developers can be easily gathered and a shortage in the supply of developers can be prevented. Particularly, the small blade 23f according to the first embodiment has a short length in the radial direction, and rarely performs a function of reducing the carrying ability as compared with the upstream end paddle 23e, so that a shortage in the supply of developers can be prevented from occurring in the downstream side of the small blade 23f without the reduction in the carrying ability.

Further, the small blade 23f according to the first embodiment extends toward the upstream side from the first main carrying blade 23d. That is, when the first main carrying blade 23d having a spiral shape carries developers, the developers are carried while being pressed toward the downstream side by the downstream side surface of the first main carrying blade 23d as shown in FIG. 6, so that a relatively large amount of developers exists in the downstream side of the first main carrying blade 23d and a small amount of developers exists in the upstream side thereof, resulting in the distribution of developers as shown in FIG. 6C. In this regard, according to the first embodiment, the small blade 23f is provided at the upstream side of the first main carrying blade 23d to allow developers to remain without difficulty, so that variation (i.e., unevenness) of the distribution of developers can be reduced.

In addition, the gap SP2 is formed between the small blade 23f according to the first embodiment and the first main carrying blade 23d, so that the carrying force can be prevented from being reduced, similarly to the case of the upstream end paddle 23e. Moreover, the upstream end surface 23f1 of the small blade 23f according to the first embodiment is inclined such that the radius thereof is increased toward the downstream side, so that the carrying ability can be prevented from being discontinuously changed and density unevenness can be prevented from occurring, similarly to the case of the upstream end paddle 23e.

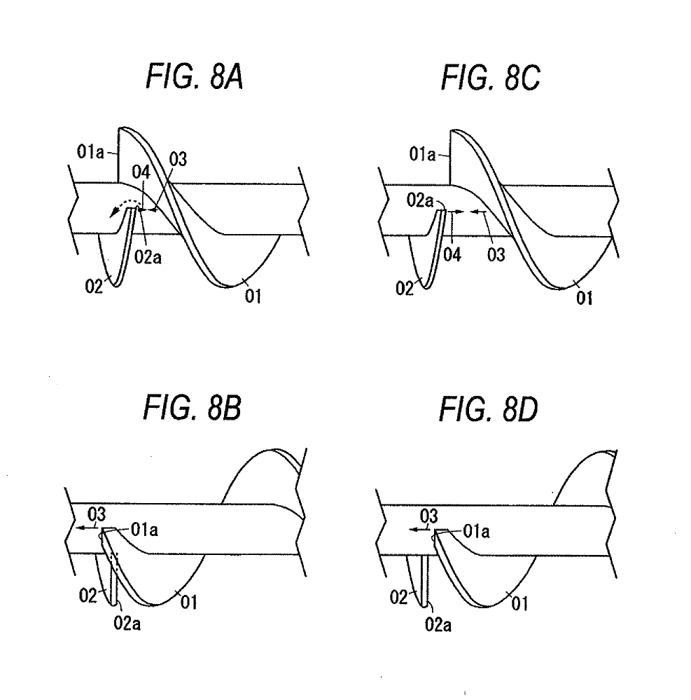

FIGS. 8A to 8D are diagrams illustrating a conventional developer carrying member, in which FIG. 8A is a diagram illustrating the configuration in which no gap is fanned in the developer carrying member, FIG. 8B is a diagram illustrating the state in which the state shown in FIG. 8A is rotated by 90°, FIG. 8C is a diagram illustrating the configuration in which a phase is not synchronized, and FIG. 8D is a diagram illustrating a state in which the state shown in FIG. 8C is rotated by 90°.

Referring to FIGS. 8A to 8D, in the conventional developer carrying member, end portions of carrying blades 01 and 02, which carry developers in directions opposite to each other, partially overlap each other along the axial direction as shown in FIGS. 8A and 8B. Further, phases of the end portions are not synchronized as shown in FIGS. 8C and 8D. Alternatively, the two cases may occur.

In FIGS. 8A and 8B, when a front end 01a of the first main carrying blade 01 is provided at a front portion as compared with a rear end 02a of the circulation carrying blade 02, a gap, in which a blade is not disposed along the axial direction, is not formed, as with the gap SP3 shown in FIG. 7 according to the first embodiment. Thus, developers carried by the first main carrying blade 01 in the first carrying direction 03 collide with developers carried by the circulation carrying blade 02 in the opposite direction 04, and are made to stay without a reduction in a carrying speed. Consequently, the developers may be rapidly deteriorated due to a load applied thereto.

Differently from the above case, in the supply auger 21 shown in FIG. 7 according to the first embodiment, the gap SP3, in which a blade is not disposed along the axial direction, is formed between the front end 23d2 of the first main carrying blade 23d and the circulation carrying blade 23c, so that developers carried by the first main carrying blade 23d collide with developers from the circulation carrying blade 23c of the downstream side in the state in which a carrying speed thereof is reduced in the gap SP3. Consequently, according to the first embodiment, as compared with a supply auger without the gap SP3, developers can be prevented from being deteriorated in the descending inlet portion E2. In addition, as compared with the supply auger without the gap SP3, developers carried by the first main carrying blade 23d remain in the gap SP3 without difficulty, so that developers can be efficiently introduced to the descending inlet portion E2.

Further, when the phases are not synchronized as shown in FIGS. 8C and 8D or when the front end 01a of the first main carrying blade 01 is provided at the front portion as compared with the rear end 02a of the circulation carrying blade 02, developers carried in the rear end 02a of the circulation carrying blade 02 in the opposite direction 04 are pressed by the first main carrying blade 01 and are returned such that they enter the upstream side of the circulation carrying blade 02. Thus, it is difficult for developers to sufficiently stay in the boundary between the first main carrying blade 01 and the circulation carrying blade 02, and the developers reciprocate in the same place and are not easily discharged from the descending inlet portion E2, so that developers may not be smoothly changed and may be deteriorated.

Differently from the above case, in the supply auger 21 shown in FIG. 7 according to the first embodiment, the front end 23d2 of the first main carrying blade 23d and the rear end 23c1 of the circulation carrying blade 23e are set to have the same phase, so that developers can be prevented from being returned to the opposite side, as compared with the cases shown in FIGS. 8A to 8D. Consequently, developers can remain in the gap SP3 without difficulty, so that developers can be efficiently introduced to the descending inlet portion E2. In addition, developers can be prevented from reciprocating in the same place and can be easily changed, so that the developers can be prevented from being deteriorated. Particularly, even if the carrying speed of developers of the supply auger 21 is high, developers carried by the first main carrying blade 23d are returned in order to sufficiently maintain their ability to remain and be introduced, and the change of developers is circulated, so that developers can be prevented from being deteriorated.

Referring to FIG. 7, in the supply auger 21 according to the first embodiment, similarly to the front end 23d2 of the first main carrying blade 23d and the rear end 23c1 of the circulation carrying blade 23c, the gap SP4 is formed between the front end 23c2 of the circulation carrying blade 23c and the rear end 23b1 serving as the upstream end of the discard carrying blade 23b, and the front end 23c2 of the circulation carrying blade 23c has the same phase as that of the rear end 23b1 of the discard carrying blade 23b. Consequently, in an area corresponding to the gap SP4, the carrying speed of developers is reduced and the change of developers is easily performed, so that developers can be prevented from being deteriorated.

Further, referring to FIG. 7, in the supply auger 21 according to the first embodiment, the number of windings of the circulation carrying blade 23c is set to 2, so that the ability to introduce developers to the descending inlet portion E2 is improved as compared with the case in which the number of windings is set to 1 and 1.5. Consequently, since an image forming speed of the copy machine U, that is, productivity, is improved, even if the carrying speed by the first main carrying blade 23d is increased, developers are carried to the descending inlet portion E2, so that developers discharged from the discharge port 3b after passing through the circulation carrying blade 23c can be prevented from being excessively increased.

In addition, according to the supply auger 21 of the first embodiment, in an area corresponding to the gap SP4, the carrying speed of developers is reduced and developers are allowed to remain without difficulty. Consequently, after the total amount of developers in the development container V is temporarily increased and developers introduced in the gap SP4 after passing through the circulation carrying blade 23c are increased, if the total amount of developers is reduced, the amount of developers staying in the gap SP4 may be increased as compared with the areas of the circulation carrying blade 23c and the discard carrying blade 23b. At this time, the circulation carrying blade 23c according to the first embodiment is formed by two windings, and developers in the gap SP4 are carried to an intermediate portion of the gap SP4 and the descending inlet portion E2 in the state in which the circulation carrying blade 23c has rotated once. In contrast, when the circulation carrying blade 23c is formed by one winding and developers in the gap SP4 are locally increased, if the locally increased developers are carried to the descending inlet portion E2 through one rotation of the circulation carrying blade 23c, the developers collide with developers carried by the first main carrying blade 23d, so that a load with respect to developers increases, resulting in the deterioration of developers. In this regard, according to the first embodiment, in the case in which developers in the gap SP4 are carried by the circulation carrying blade 23c, the developers are carried to an intermediate portion between the gap SP4, in which the amount of developers is relatively small, and the descending inlet portion E2 so as to be uniform when the circulation carrying blade 23c rotates once, as compared with the gap SP4 and the descending inlet portion E2. Then, if the circulation carrying blade 23c rotates twice, the developers are carried to the descending inlet portion E2, so that a load with respect to the developers is reduced, resulting in the prevention of deterioration of the developers.

While there have been described what are at present considered to be a certain embodiment of the invention, it will be understood that various modifications may be made thereto, and it is intended that the appended claims cover all such modifications as fall within the true spirit and scope of the invention. Hereinafter, modified examples H01 to H012 of the invention will be described.

(H01) In the previous embodiment, a copy machine is exemplified as an image forming apparatus. However, the invention is not limited thereto. For example, the image forming apparatus may be formed by a printer, a facsimile or a multifunctional device having a plurality of functions or all functions thereof.

(H02) In the previous embodiment, the copy machine U uses developers of four colors. However, the invention is not limited thereto. For example, the invention can also be applied to a monochromatic image forming apparatus and a multicolored image forming apparatus of five colors or more or three colors or less.

(H03) In the previous embodiment, it is preferred that the gaps SP1 and SP2 are formed between the upstream end paddle 23e and the small blade 23f and between the small blade 23f and the first main carrying blade 23d, respectively. However, the upstream end paddle 23e and the small blade 23f may be connected to the first main carrying blade 23d without any gap. In contrast, an end of one of the upstream end paddle 23e and the small blade 23f may be connected to the first main carrying blade 23d, or ends of both of the upstream end paddle 23e and the small blade 23f may be separated from the first main carrying blade 23d.

(H04) In the previous embodiment, it is preferred that the end surface 23e1 of the upstream end paddle 23e and the end 23f1 of the small blade 23f are inclined. However, the end surfaces 23e1 and 2311 may extend in the radial direction without being inclined.

(H05) In the previous embodiment, it is preferred to provide the small blade 23. However, the small blade 23 may be omitted.

(H06) In the previous embodiment, the upstream end paddle 23e and the small blade 23f have a plate shape to extend in the axial direction. However, the invention is not limited to such a configuration. For example, the upstream end paddle 23e and the small blade 23f may have a plate shape inclined in the axial direction or may include a plurality of plates.

(H07) In the previous embodiment, the developing devices Gy, Gm, Gc and Gk, in which the first stirring chamber 6 and the second stirring chamber 7 are obliquely disposed, are exemplified. However, the invention is not limited to such a configuration. For example, the invention can also be applied to a developing device in which the first stirring chamber 6 and the second stirring chamber 7 are disposed in a row in the horizontal direction or the gravitational direction.

(H08) In the previous embodiment, it is preferred that the rear end blade 23d 1 of the first main carrying blade 23d is laid down on the first rotating shaft 22, as compared with the other blades. However, the invention is not limited to such a configuration. For example, the rear end blade 23d1 may have the same shape as those of other blades.

(H09) In the previous embodiment, a spiral blade is exemplified as the first main carrying blade 23d. However, the invention is not limited to such a configuration. For example, it may be possible to employ a configuration in which a plate having a semicircular shape is supported while being inclined with respect to the first rotating shaft 22.

(H10) Differently from the previous embodiment, the number of windings, the pitch and the like of the spiral blades 23a to 23d and 28a to 28d are not limited to the configuration exemplified in the previous embodiment. For example, they may be arbitrarily changed according to design, specifications and the like.

(H11) In the previous embodiment, it is preferred that the phases of the rear end 23c1 of the circulation carrying blade 23c and the front end 23d2 of the first main carrying blade 23d are synchronized, and the phases of the front end 23c2 of the circulation carrying blade 23c and the rear end 23b1 of the discard carrying blade 23b are synchronized. However, phases of any one of them or both of them may be deviated. In contrast, the phases of the rear end of the first supply carrying blade 23a and the front end of the discard carrying blade 23b may be synchronized.

(H12) In the previous embodiment, it is preferred that the gaps SP3 and SP4 are formed between the circulation carrying blade 23c and the first main carrying blade 23d and between the circulation carrying blade 23c and the discard carrying blade 23b, respectively. However, any one of them or both of them may be omitted.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A developing device comprising:
a developer holder that rotates while holding developers on a surface thereof;
a first chamber that contains the developers supplied to the developer holder;
a second chamber that contains the developers carried from the first chamber after being circulated between the first chamber and the second chamber;
a first inlet portion that connects the first chamber and the second chamber, and at least a part of the first inlet portion overlapping a developer-holding portion of the developer holder;
a second inlet portion that connects the first chamber and the second chamber;
a first carrying member that is disposed in the first chamber, and that carries the developers in the first chamber in a first carrying direction directed toward the second inlet portion; and
a second carrying member that is disposed in the second chamber, and that carries the developers in the second chamber in a second carrying direction directed toward the first inlet portion,
wherein the first carrying member includes (i) a rotating shaft, (ii) a spiral blade provided at an outer periphery of the rotating shaft, and (iii) an auxiliary blade formed toward an upstream side of the first carrying direction from the spiral blade wall, and
a gap is formed between an upstream end of the auxiliary blade and the spiral blade wall in the first carrying direction.

2. The developing device according to claim 1, further comprising:
a feeding blade that is provided at the upstream end portion of the first carrying direction of the first carrying member, and that feeds the developers to the developer holder, the developers being introduced to the first chamber from the first inlet portion,
wherein the first carrying member is provided at a position overlapping a downstream-side end portion of the first inlet portion.

3. The developing device according to claim 1,
wherein the first carrying member includes the feeding blade provided at an outer periphery of the rotating shaft to extend in an axial direction, and
the feeding blade has a plate shape.

4. The developing device according to claim 3,
wherein a gap is formed between a downstream end of the feeding blade and the spiral blade wall in the first carrying direction.

5. The developing device according to claim 3,
wherein an outer end of a radial direction of the feeding blade is inclined toward a direction separated from the rotating shaft as it is toward a direction of the upstream side from the downstream end of the first carrying direction.

6. The developing device according to claim 1,
wherein the auxiliary blade has a rotation radius which is smaller than a rotation radius of the feeding blade.

7. The developing device according to claim 6,
wherein the auxiliary blade is provided at an outer periphery of the rotating shaft, and
the auxiliary blade has a plate shape which extends toward an upstream side of the first carrying direction of the spiral blade from an upstream end surface of the auxiliary blade.

8. The developing device according to claim 7,
wherein an outer end of a radius direction of the auxiliary blade is inclined toward a direction separated from the rotating shaft as it is toward a direction of a downstream side from the upstream end of the first carrying direction.

9. An image forming apparatus comprising:
a rotary image holder;
a latent image forming device that forms a latent image on a surface of the image holder;
a developing device according to claim 1, which develops the latent image on the surface of the image holder into a toner image;
a transfer device that transfers the toner image on the surface of the image holder to a medium; and
a fixing device that fixes the toner image on a surface of the medium.

10. The image forming apparatus according to claim 9, further comprising:
a feeding blade that is provided at the upstream end portion of the first carrying direction of the first carrying member, and that feeds the developers to the developer holder, the developers being introduced to the first chamber from the first inlet portion,
wherein the first carrying member is provided at a position overlapping a downstream-side end portion of the first inlet portion.

11. The image forming apparatus according to claim 9,
wherein the first carrying member includes the feeding blade provided at an outer periphery of the rotating shaft to extend in an axial direction, and
the feeding blade has a plate shape.

12. The image forming apparatus according to claim 11,
wherein a gap is formed between a downstream end of the feeding blade and spiral blade wall in the first carrying direction.

13. The image forming apparatus according to claim 11,
wherein an outer end of a radial direction of the feeding blade is inclined toward a direction separated from the rotating shaft as it is toward a direction of the upstream side from the downstream end of the first carrying direction.

14. The image forming apparatus according to claim 9,
wherein the auxiliary blade has a rotation radius which is smaller than a rotation radius of the feeding blade.

15. The image forming apparatus according to claim 14,
wherein the auxiliary blade is provided at an outer periphery of the rotating shaft, and
the auxiliary blade has a plate shape which extends toward an upstream side of the first carrying direction of the spiral blade from an upstream end surface of the auxiliary blade.

16. The image forming apparatus according to claim 15,
wherein an outer end of a radius direction of the auxiliary blade is inclined toward a direction separated from the rotating shaft as it is toward a direction of a downstream side from the upstream end of the first carrying direction.
